(19) United States
(12) Patent Application Publication
(10) Pub. No.: US 2023/0337256 A1
(43) Pub. Date: Oct. 19, 2023

(54) HYBRID AUTOMATIC REPEAT REQUEST FEEDBACK CODEBOOK FOR MULTI-CELL SCHEDULING

(71) Applicant: QUALCOMM Incorporated, San Diego, CA (US)

(72) Inventors: Kazuki TAKEDA, Minato-ku (JP); Mostafa KHOSHNEVISAN, San Diego, CA (US); Peter GAAL, San Diego, CA (US); Juan MONTOJO, San Diego, CA (US); Wanshi CHEN, San Diego, CA (US); Alberto RICO ALVARINO, San Diego, CA (US)

(21) Appl. No.: 18/178,989

(22) Filed: Mar. 6, 2023

Related U.S. Application Data
(60) Provisional application No. 63/362,991, filed on Apr. 14, 2022.

(51) Int. Cl. H04W 72/232; H04L 1/1812; H04W 72/12

(52) U.S. Cl. CPC H04W 72/232; H04L 1/1812; H04W 72/12

(57) ABSTRACT

Various aspects of the present disclosure generally relate to wireless communication. In some aspects, a user equipment (UE) may receive one or more physical downlink shared channel (PDSCH) communications scheduled by downlink control information (DCI). The UE may transmit, for the one or more PDSCH communications, hybrid automatic repeat request (HARQ) feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling on a single carrier or a second format configured for scheduling on a plurality of carriers. Numerous other aspects are described.

### CROSS-REFERENCE TO RELATED APPLICATION

This patent application claims priority to U.S. Provisional Patent Application No. 63/362,991, filed on Apr. 14, 2022, entitled “HYBRID AUTOMATIC REPEAT REQUEST FEEDBACK CODEBOOK FOR MULTI-CELL SCHEDULING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for hybrid automatic repeat request feedback codebook for multi-cell scheduling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving one or more physical downlink shared channel (PDSCH) communications scheduled by downlink control information (DCI). The method may include transmitting, for the one or more PDSCH communications, hybrid automatic repeat request (HARQ) feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to a method of wireless communication performed by a network node. The method may include transmitting one or more PDSCH communications scheduled by DCI. The method may include receiving, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to a UE for wireless communication. The UE may include a memory and one or more processors coupled to the memory. The one or more processors may be configured to receive one or more PDSCH communications scheduled by DCI. The one or more processors may be configured to transmit, for the one or more PDSCH communications, HARQ feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to a network node for wireless communication. The network node may include a memory and one or more processors coupled to the memory. The one or more processors may be configured to transmit one or more PDSCH communications scheduled by DCI. The one or more processors may be configured to receive, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to a non-transitory computer-readable medium that stores a set of instructions for wireless communication by a UE. The set of instructions, when executed by one or more processors of the UE, may cause the UE to receive one or more PDSCH communications scheduled by DCI. The set of instructions, when executed by one or more processors of the UE, may cause the UE to transmit, for the one or more PDSCH communications, HARQ feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to a non-transitory computer-readable medium that stores a set of instructions for wireless communication by a network node. The set of instructions, when executed by one or more processors of the network node, may cause the network node to transmit one or more PDSCH communications scheduled by DCI. The set of instructions, when executed by one or more processors of the network node, may cause the network node to receive, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to an apparatus for wireless communication. The apparatus may include means for receiving one or more PDSCH communications scheduled by DCI. The apparatus may include means for transmitting, for the one or more PDSCH communications, HARQ feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Some aspects described herein relate to an apparatus for wireless communication. The apparatus may include means for transmitting one or more PDSCH communications scheduled by DCI. The apparatus may include means for receiving, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Aspects generally include a method, apparatus, system, computer program product, non-transitory computer-readable medium, user equipment, base station, network node, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of physical channels and reference signals in a wireless network, in accordance with the present disclosure.

FIG. 5 is a diagram illustrating an example of carrier aggregation, in accordance with the present disclosure.

FIG. 6 is a diagram illustrating an example of downlink control information (DCI) that schedules multiple cells, in accordance with the present disclosure.

FIGS. 7A-7D are diagrams illustrating examples associated with using a hybrid automatic repeat request (HARQ) feedback codebook in a multi-cell scheduling scenario, in accordance with the present disclosure.

FIGS. 8-9 are diagrams illustrating example processes associated with using a HARQ feedback codebook in a multi-cell scheduling scenario, in accordance with the FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

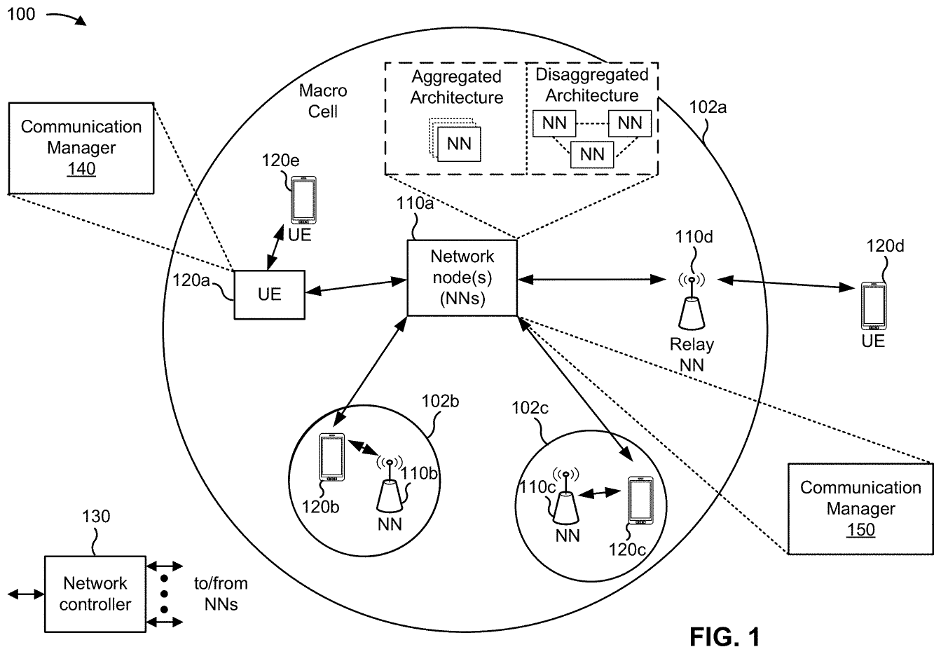

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive one or more physical downlinks shared channel (PDSCH) communications scheduled by downlink control information (DCI); and transmit, for the one or more PDSCH communications, hybrid automatic repeat request (HARQ) feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit one or more PDSCH communications scheduled by DCI; and receive, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers. Additionally, or alternatively, the communication manager 150 may perform one or more other operations described herein.

As indicated above, FIG. 1 is provided as an example. Other examples may differ from what is described with regard to FIG. 1.

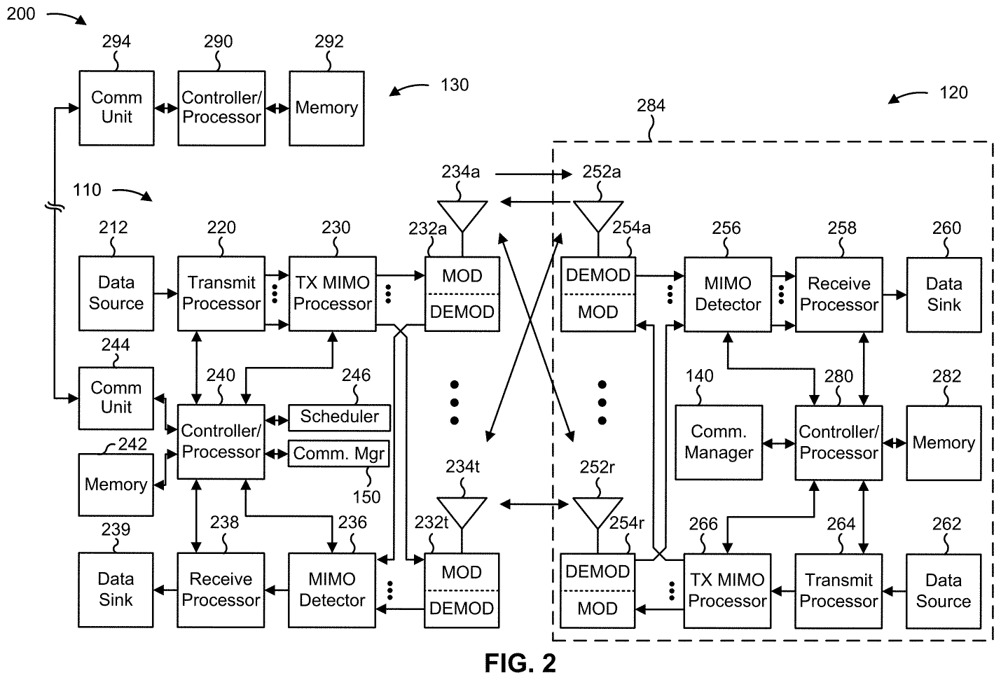

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

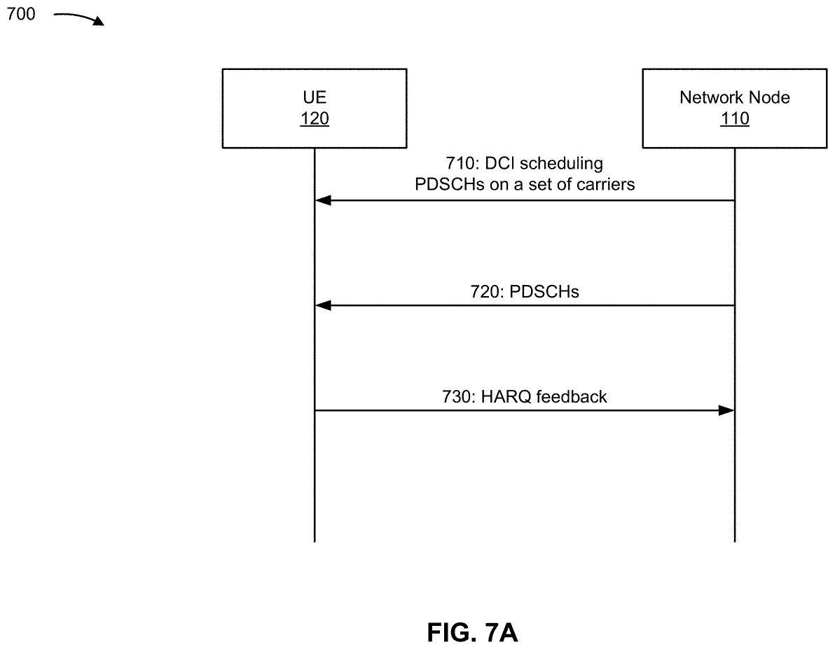

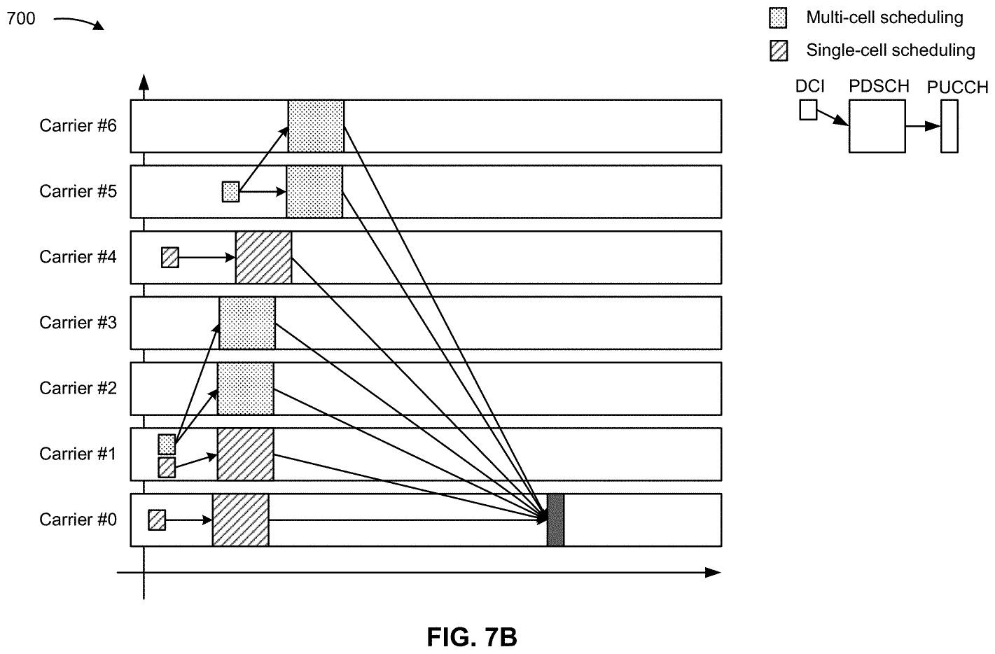

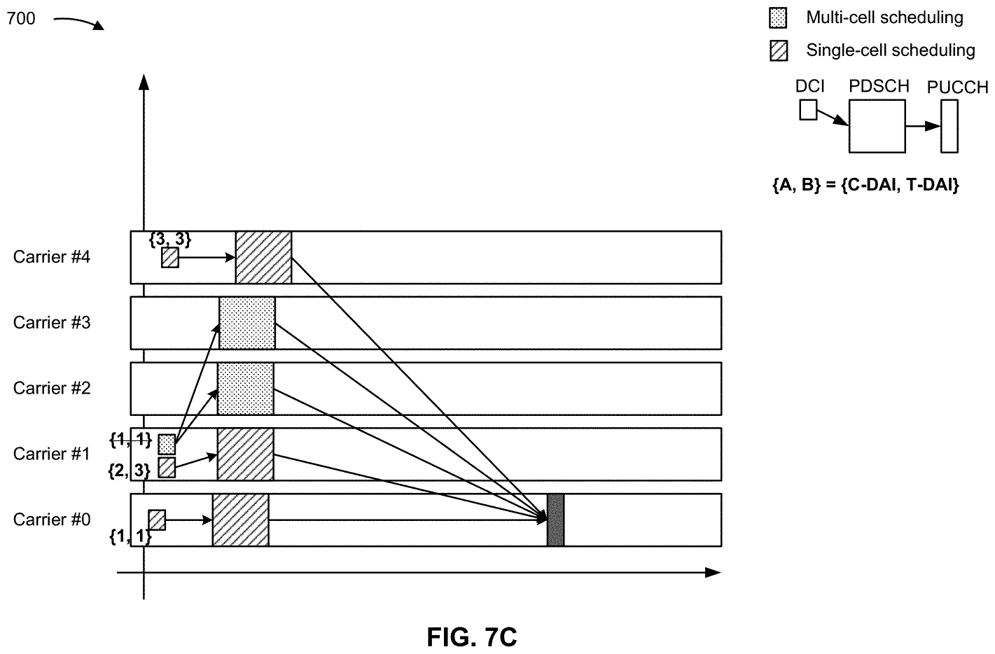

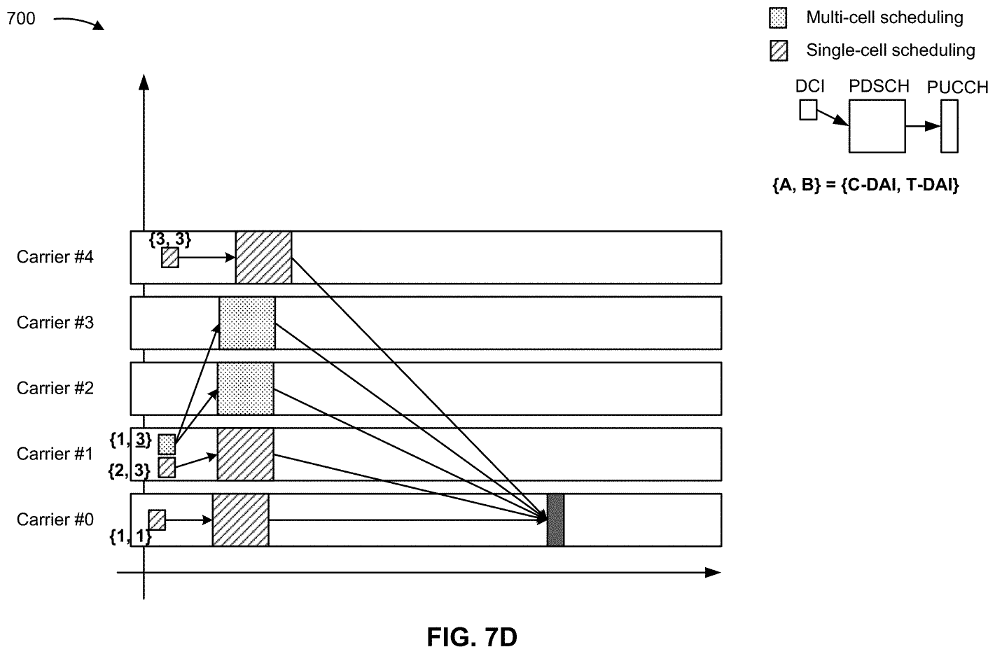

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-11).

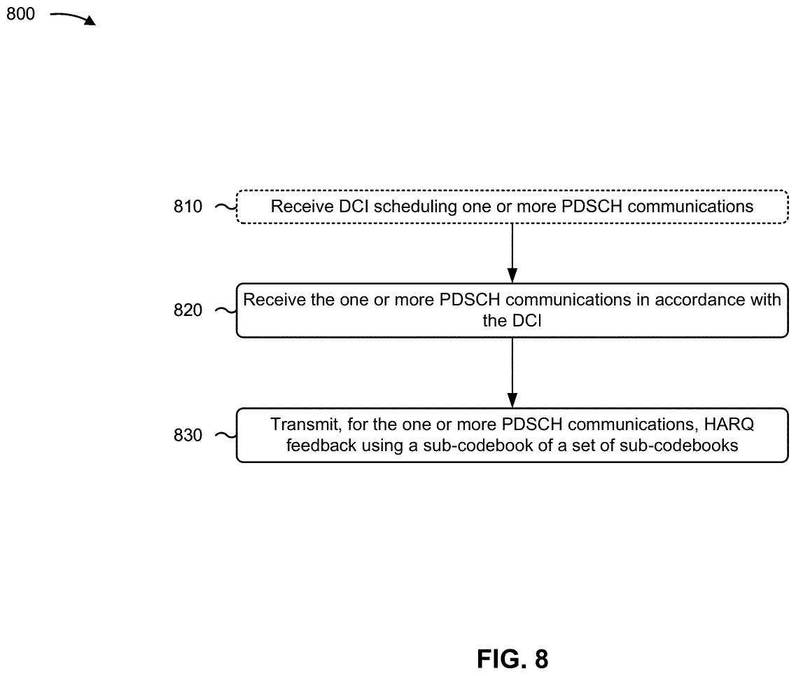

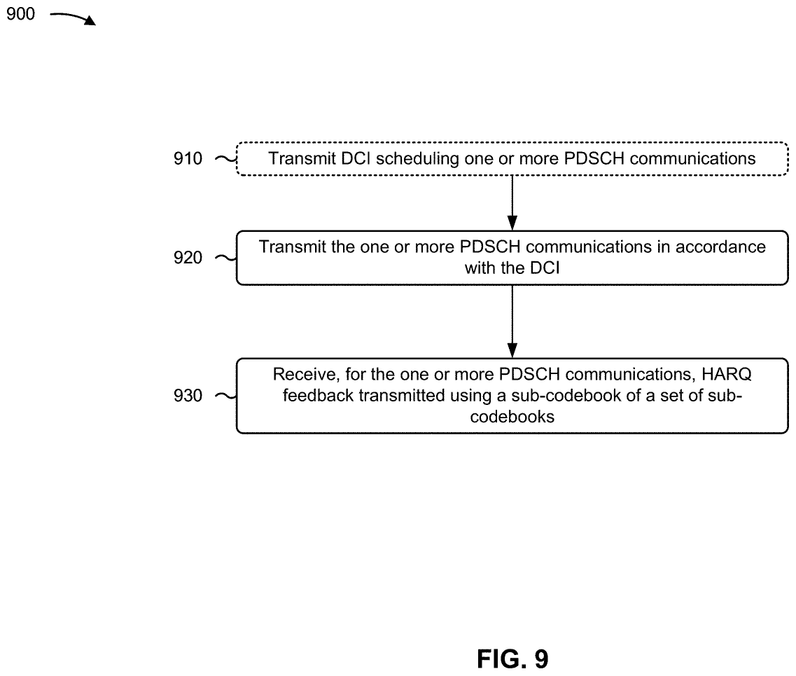

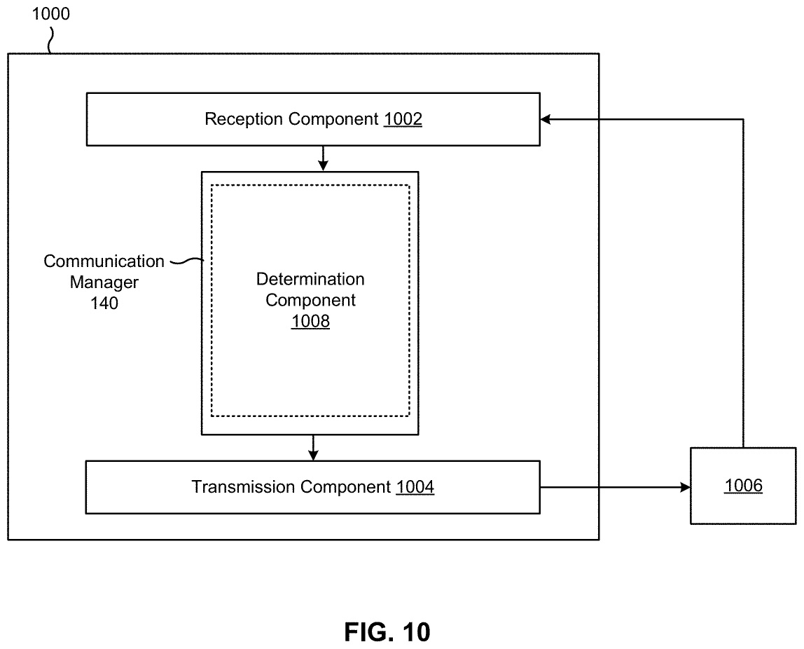

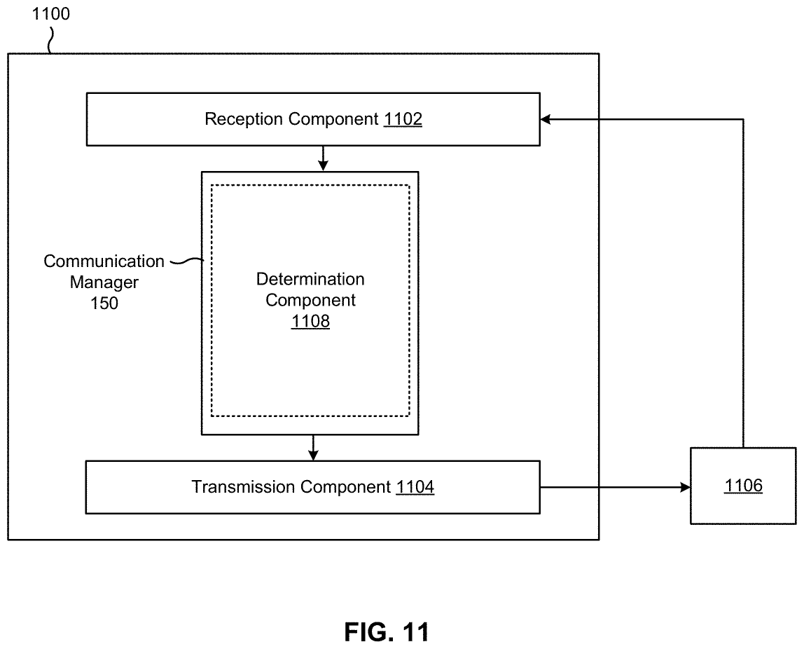

The controller/processor 240 of the network node 110, the controller/processor 280 of the UE 120, and/or any other component(s) of FIG. 2 may perform one or more techniques associated with using a HARQ feedback codebook in a multi-cell scheduling scenario, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving one or more PDSCH communications scheduled by DCI; and/or means for transmitting, for the one or more PDSCH communications, HARQ feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting one or more PDSCH communications scheduled by DCI; and/or means for receiving, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network node, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

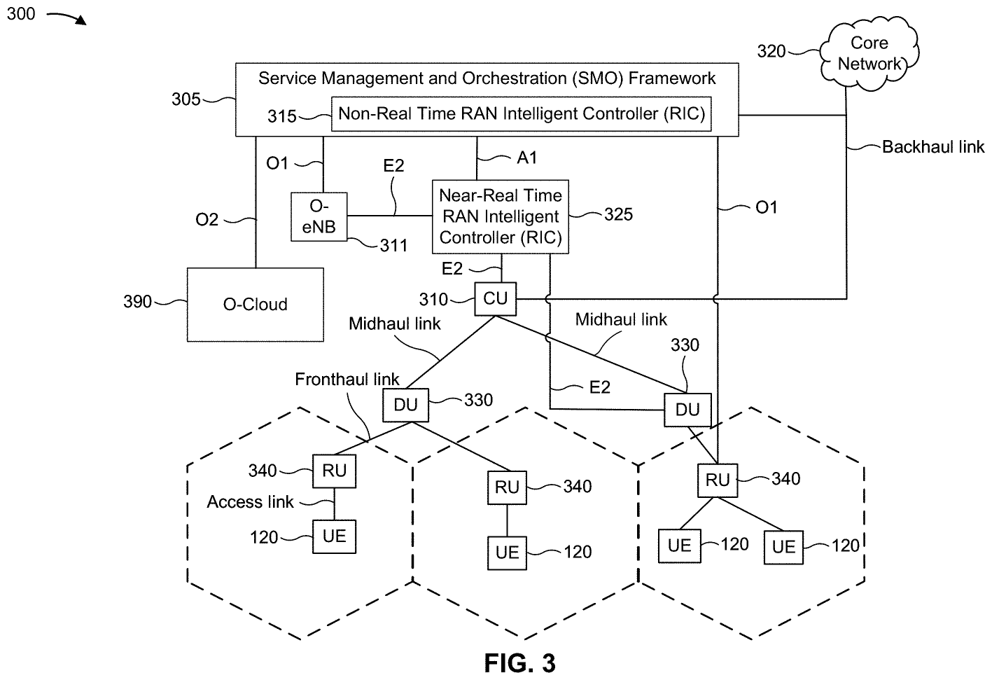

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

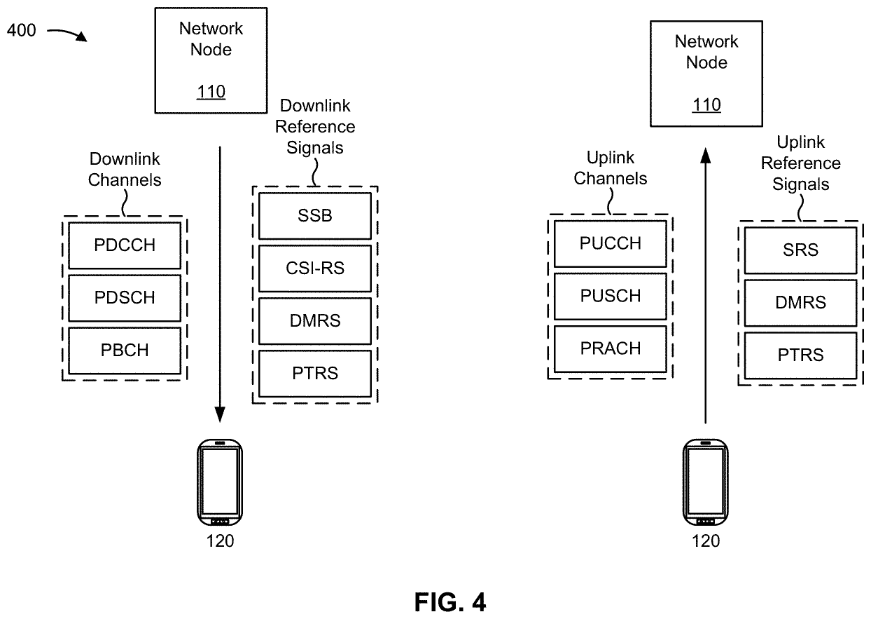

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries DCI, a PDSCH that carries downlink data, or a physical broadcast channel (PBCH) that carries system information, among other examples. PDSCH communications may be scheduled by PDCCH communications. For example, DCI of a PDCCH conveyed on a first carrier may include scheduling information to schedule a PDSCH on the first carrier and/or one on or more second carriers (e.g., in a cross-carrier scheduling scenario). As further shown, an uplink channel may include a physical uplink control channel (PUCCH) that carries uplink control information (UCI), a physical uplink shared channel (PUSCH) that carries uplink data, or a PRACH used for initial network access, among other examples. The UE 120 may transmit acknowledgement (ACK) or negative acknowledgement (NACK) feedback (e.g., ACK/NACK feedback or ACK/NACK information) in UCI on the PUCCH and/or the PUSCH. The UE 120 may transmit HARQ feedback (e.g., a HARQ ACK or a HARQ NACK) using a HARQ codebook, which may also be referred to as a “HARQ ACK codebook,” a “HARQ-ACK codebook,” or a “HARQ feedback codebook,” among other examples.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. The network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. The network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

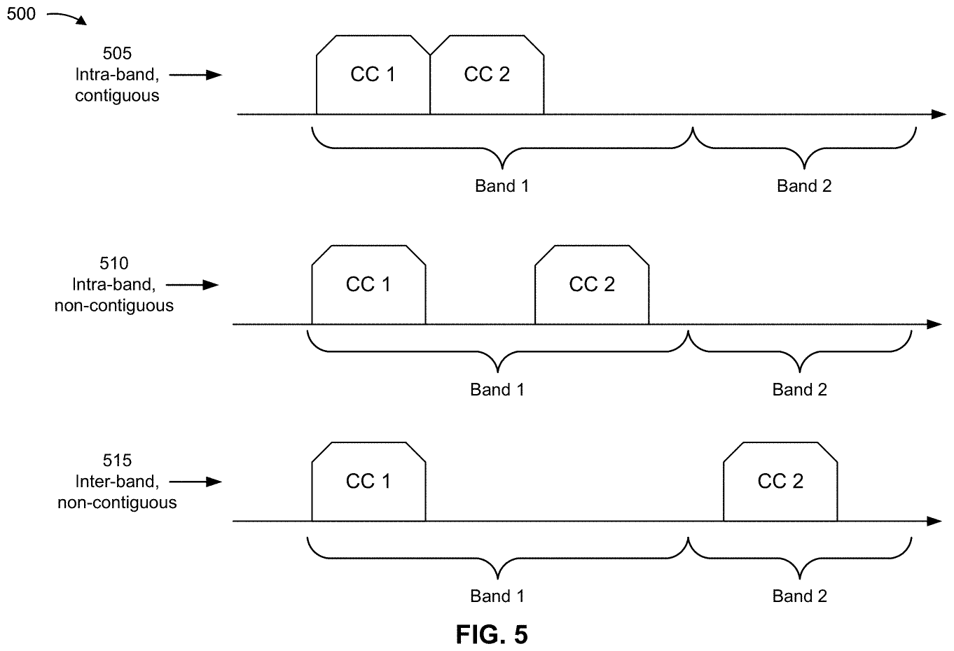

FIG. 5 is a diagram illustrating examples 500 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node may configure carrier aggregation for a UE 120, such as in an RRC message, DCI, and/or another signaling message.

As shown by reference number 505, carrier aggregation may be configured in an intra-band contiguous mode where the aggregated carriers are contiguous to one another and are in the same band. As shown by reference number 510, carrier aggregation may be configured in an intra-band non-contiguous mode where the aggregated carriers are non-contiguous to one another and are in the same band. As shown by reference number 515, aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). The primary carrier may carry control information (e.g., DCI and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 5 is provided as an example. Other examples may differ from what is described with regard to FIG. 5.

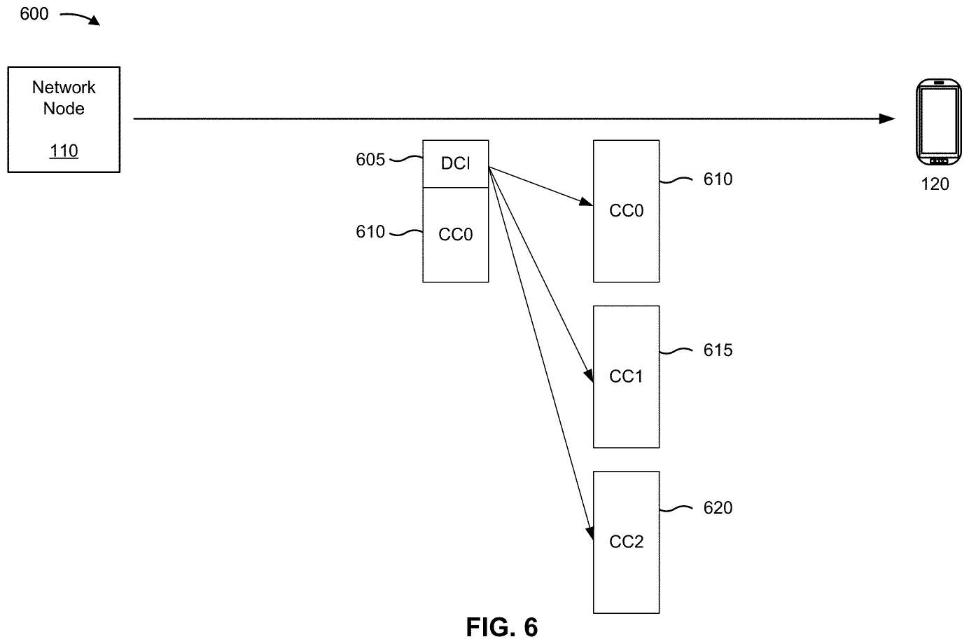

FIG. 6 is a diagram illustrating an example 600 of DCI that schedules multiple cells, in accordance with the present disclosure. As shown in FIG. 6, a network node 110 and a UE 120 may communicate with one another.

The network node 110 may transmit, to the UE 120, DCI 605 that schedules multiple communications for the UE 120. The multiple communications may be scheduled for at least two different cells. In some cases, a cell may be referred to as a carrier or a component carrier (CC). In some cases, DCI that schedules a communication for a cell via which the DCI is transmitted may be referred to as self-carrier (or self-cell) scheduling DCI. In some cases, DCI that schedules a communication for a cell via which the DCI is transmitted may be referred to as cross-carrier (or cross-cell) scheduling DCI. The DCI 605 may be cross-carrier scheduling DCI, and may or may not be self-carrier scheduling DCI. The DCI 605 that carries communications in at least two cells may be referred to as combination DCI.

In example 600, the DCI 605 schedules a communication for a first cell 610 that carries the DCI 605 (shown as CC0), schedules a communication for a second cell 615 that does not carry the DCI 605 (shown as CC1), and schedules a communication for a third cell 620 that does not carry the DCI 605 (shown as CC2). The DCI 605 may schedule communications on a different number of cells than shown in FIG. 6 (e.g., two cells, four cells, five cells, and so on). The number of cells may be greater than or equal to two.

A communication scheduled by the DCI 605 may include a data communication, such as a PDSCH communication or a PUSCH communication. For a data communication, the DCI 605 may schedule a single transport block (TB) across multiple cells or may separately schedule multiple TBs in the multiple cells. Additionally, or alternatively, a communication scheduled by the DCI 605 may include a reference signal, such as a CSI-RS or an SRS. For a reference signal, the DCI 605 may trigger a single resource for reference signal transmission across multiple cells or may separately schedule multiple resources for reference signal transmission in the multiple cells. In some cases, scheduling information in the DCI 605 may be indicated once and reused for multiple communications (e.g., on different cells), such as an MCS, a resource to be used for a HARQ ACK or NACK of a communication scheduled by the DCI 605, and/or a resource allocation for a scheduled communication, to conserve signaling overhead.

As indicated above, FIG. 6 is provided as an example. Other examples may differ from what is described with respect to FIG. 6.

As described above, a network node may transmit DCI to a UE to schedule a PDSCH in a set of carriers or cells. For example, the network node may transmit a single-cell scheduling DCI to schedule a PDSCH in a single carrier or a multi-cell scheduling DCI to schedule PDSCHs in a plurality of carriers. A multi-cell scheduling DCI may be a format of DCI that is configured to be able to schedule a PDSCH on up to N cells, where N>1. In some cases, whether such a DCI actually does schedule the PDSCH on multiple cells or does not, the DCI is a classified as a multi-cell scheduling DCI and corresponding PDSCHs are multi-cell scheduled PDSCHs. In some other cases, when such a DCI does not schedule the PDSCH on multiple cells (despite the format of DCI having fields providing a capability of scheduling the PDSCH on multiple cells), the DCI is classified as a single-cell scheduling DCI and corresponding PDSCHs are single-cell scheduled PDSCHs (e.g., despite being scheduled by a format of DCI for multi-cell scheduling).

In carrier aggregation, both single-cell scheduling and multi-cell scheduling may be allowed. For example, a network node my transmit a first set of single-cell scheduling DCIs to schedule PDSCHs on a first set of cells and a second set of multi-cell scheduling DCIs to schedule PDSCHs on a second set of cells. The network node may provide uplink channel resources, such as in a PUCCH or a PUSCH, that a UE can use to transmit HARQ feedback for a scheduled PDSCH. The UE may have a first codebook for transmitting HARQ feedback for single-cell scheduled PDSCHs in a first PUSCH or PUCCH resource and a second codebook for transmitting HARQ feedback for multi-cell scheduled PDSCHs in a second PUSCH or PUCCH resource. However, transmitting HARQ feedback for single-cell scheduled PDSCHs and multi-cell scheduled PDSCHs may result in an excessive utilization of network resources.

Some aspects described herein enable a UE to construct a joint codebook for single-cell scheduled PDSCH and multi-cell scheduled PDSCH HARQ feedback using a common uplink resource. In this case, the UE may form a HARQ feedback codebook by concatenating two sub-codebooks. For example, the UE may concatenate or otherwise combine a first sub-codebook for single-cell scheduling and a second sub-codebook for multi-cell scheduling. In some aspects, the order of combination may be multi-cell scheduling first and single-cell scheduling second or vice versa. In this case, the UE may use the combined codebook to generate HARQ feedback that the UE transmits using, for example, a single PUSCH or PUCCH resource, thereby reducing a utilization of network resources relative to having separate uplink channel resources for single-cell scheduling HARQ feedback and multi-cell scheduling HARQ-feedback.

FIGS. 7A-7D are diagrams illustrating an example 700 associated with using a HARQ feedback codebook in a multi-cell scheduling scenario, in accordance with the present disclosure. As shown in FIG. 7A, a network node 110 and a UE 120 may communicate with one another.

As further shown in FIG. 7A, and by reference number 710, the UE 120 may receive DCI scheduling PDSCHs on a set of carriers. For example, the UE 120 may receive, from the network node 110, a first set of DCI messages associated with single-cell scheduling of PDSCHs and a second set of DCI messages associated with multi-cell scheduling of PDSCHs. In this case, as shown in FIG. 7B, for single-cell scheduling, the UE 120 receives, in a first format, DCI on carrier #0 schedules a PDSCH on carrier #0, DCI on carrier #1 schedules a PDSCH on carrier #1, and DCI on carrier #4 schedules a PDSCH on carrier #4. Further, for multi-cell scheduling, the UE 120 receives, in a second format, DCI on carrier #1 schedules PDSCHs on carriers #2 and #3 and DCI on carrier #5 schedules PDSCHs on carriers #5 and #6, as shown.

Returning to FIG. 7A, and as shown by reference number 720, the UE 120 may attempt to receive one or more PDSCHs. For example, the UE 120 may receive, from the network node 110, single-cell scheduled PDSCHs and/or multi-cell scheduled PDSCHs on one or more carriers. In this case, as shown in FIG. 7B, for single-cell scheduling, the UE 120 may attempt to receive PDSCHs on carriers #0 through #6.

In some aspects, whether a particular DCI format is for single-cell scheduling or multi-cell scheduling is semi-statically configured. For example, the UE 120 may receive semi-static signaling (e.g., RRC signaling) indicating whether to monitor for a first DCI format or a second DCI format in a cell. Additionally, or alternatively, the UE 120 may receive signaling (e.g., RRC or DCI) indicating whether to monitor for a first format of DCI (e.g., for single-cell scheduling) or a second format of DCI (e.g., for multi-cell scheduling) in a cell. In this case, the UE 120 may monitor for both the first format and the second format and the received DCI, itself, may indicate whether the received DCI is the first format or the second format. Additionally, or alternatively, the UE 120 may determine whether the second format of DCI in a cell is considered as a DCI for single-cell scheduling or for multi-cell scheduling depending on the condition. For example, if the second format of DCI in a cell schedules PDSCH only on one cell, the UE may determine the second format of DCI in the cell is a DCI for single-cell scheduling.

Returning to FIG. 7A, and as shown by reference number 730, the UE 120 may transmit HARQ feedback. For example, the UE 120 may transmit a HARQ feedback message (e.g., one or more HARQ-ACKs or HARQ-NACKs) via an uplink channel resource. In this case, as shown in FIG. 7B, the UE 120 may multiplex HARQ feedback from carriers #0 through #6 onto a single PUCCH resource. Additionally, or alternatively, the UE 120 may multiplex the HARQ feedback onto a single PUSCH resource. In this case, by multiplexing HARQ feedback from both single-cell scheduled PDSCHs and multi-cell scheduled PDSCHs onto a single uplink channel resource, the UE 120 reduces a utilization of network resources relative to using separate uplink channel resources for different types of DCIs and associated PDSCHs (e.g., single-cell scheduling DCIs and single-cell scheduled PDSCHs and multi-cell scheduling DCIs and multi-cell scheduled PDSCHs).

In some aspects, the UE 120 may use a codebook for transmission of combined HARQ feedback (e.g., HARQ feedback that can be for a single-cell scheduled PDSCH and for a multi-cell scheduled PDSCH). For example, the UE 120 may concatenate a first sub-codebook that is assigned for HARQ feedback for PDSCHs scheduled by a first format of DCI (e.g., a format of DCI for single-cell scheduling) and a second sub-codebook that is assigned for HARQ feedback for PDSCHs scheduled by a second format of DCI (e.g., a format of DCI for multi-cell scheduling). Although some aspects are described herein in terms of a concatenation operation, other types of combination operations may be possible. Additionally, or alternatively, the codebook, which is concatenated as described herein, may be a static codebook rather than a constructed codebook. In other words, rather than the UE 120 constructing a codebook by concatenating sub-codebooks, the UE 120 may be provided with the codebook, which may correspond to a concatenation of two sub-codebooks (e.g., if two sub-codebooks were concatenated they would form a codebook that is the same as the codebook with which the UE 120 is provided).

In some aspects, the UE 120 may determine a downlink assignment index (DAI) value in connection with the HARQ feedback. For example, a counter DAI (C-DAI) value, which counts a quantity of transmitted DCIs up to a current serving cell and a current PDCCH monitoring occasion, may be incremented on a per sub-codebook basis (e.g., separated C-DAI values correspond to HARQ feedback for a first format of DCI and a second format of DCI). In this way, the UE 120 avoids codebook size misalignment when a DCI other than a last DCI associated with a last HARQ ACK in a sub-codebook is missed (e.g., not successfully received). Similarly, a total DAI (T-DAI) value, which counts a total quantity of DCIs up to a current PDCCH monitoring occasion (e.g., in some T-DAI interval before being reset), is updated on per sub-codebook basis. In this way, the UE 120 avoids codebook size misalignment when a DCI associated with a last HARQ ACK in a sub-codebook is missed.

In some aspects, the UE 120 may generate the HARQ ACK feedback based at least in part on a configuration for monitoring for the DCI. For example, when the UE is statically indicated whether to monitor for a first format of DCI or a second format of DCI, as described above, the UE 120 may generate, for single-cell scheduling, one or two HARQ ACK bits per DAI count for PUCCH or PUSCH transmission. In this case, when the UE 120 is configured with a parameter maxNrofCodeWordsScheduledByDCI with two transport blocks for at least one downlink bandwidth part of at least one serving cell where a DCI for single-cell scheduling can schedule PDSCH, and when the UE 120 is not configured with a harq-ACK-SpatialBundlingPUCCH parameter or a harq-ACK-SpatialBudlingPUSCH parameter in a cell group or PUCCH group, the UE 120 may generate two HARQ ACK bits. Alternatively, when the UE 120 is not configured with the parameter maxNrofCodeWordsScheduledByDCI or when the UE 120 is configured with either of the parameters harq-ACK-SpatialBundlingPUCCH or harq-ACK-SpatialBudlingPUSCH, the UE 120 may generate one HARQ ACK bit.

Similarly, the UE 120 may generate, for multi-cell scheduling, a quantity Nmax HARQ bits per DAI count. In some aspects, the parameter Nmax may be based at least in part on a quantity of PDSCH receptions that can be scheduled by a DCI for multi-cell scheduling (in a particular carrier aggregation configuration) NPDSCH and based at least in part on a quantity of transport blocks for PUCCH or PUSCH transmission NTB, for example, where Nmax=NPDSCH×NTB. When the UE 120 is configured with the parameter maxNrofCodeWordsScheduledByDCI with two transport blocks for at least one downlink bandwidth part of at least one serving cell where a DCI for multi-cell scheduling can schedule PDSCHs, and when the UE 120 is not configured with the harq-ACK-SpatialBundlingPUCCH parameter or the harq-ACK-SpatialBudlingPUSCH parameter in a cell group or PUCCH group, the quantity of transport blocks is two. Alternatively, when the UE 120 is not configured with the parameter maxNrofCodeWordsScheduledByDCI or when the UE 120 is configured with either of the parameters harq-ACK-SpatialBundlingPUCCH or harq-ACK-SpatialBudlingPUSCH, the quantity of transport blocks is one. Additionally, or alternatively, the UE 120 may set the quantity of transport blocks as one in any serving cell where a DCI for multi-cell scheduling can schedule PDSCHs. In some aspects, the harq-ACK-SpatialBundlingPUCCH parameter or the harq-ACK-SpatialBudlingPUSCH parameter can be set on a per cell basis for single-cell scheduling or multi-cell scheduling to enable configuration of different values for NTB for single-cell scheduling and multi-cell scheduling.

In some aspects, the parameter Nmax may be based at least in part on a static configuration. For example, the UE 120 may receive RRC signaling identifying a value for Nmax. In this case, when Nmax>NTB×NPDSCH, the UE 120 may include HARQ ACK feedback up to NTB×NPDSCH bits and may fill in NACK bits for Nmax−NTB×NPDSCH bits (e.g., as padding). Additionally, or alternatively, when Nmax<NTB×NPDSCH, the UE 120 may use one or more logical operations (e.g., AND operations) to combine multiple HARQ ACK bits to reduce NTB×NPDSCH to equal Nmax. Although some aspects are described herein in terms of the UE 120 performing the aforementioned logical operations, in some aspects, the UE 120 may reduce the HARQ ACK bits in another form, such as by using a lookup table (e.g., which may be based at least in part on a logical operation). In some aspects, the harq-ACK-SpatialBundlingPUCCH parameter or the harq-ACK-SpatialBudlingPUSCH parameter can be set on a per cell basis for single-cell scheduling or multi-cell scheduling to enable configuration of different values for NTB for single-cell scheduling and multi-cell scheduling.

Additionally, or alternatively, when the UE is dynamically indicated whether to monitor for a first format of DCI or a second format of DCI, as described above, the UE may generate, for single-cell scheduling, one or two HARQ ACK bits per DAI count for PUCCH or PUSCH transmission. In this case, when the UE 120 is configured with maxNrofCodeWordsScheduledByDCI with two transport blocks for at least one downlink bandwidth part of at least one serving cell in a cell group of PUCCH group, and when the UE 120 is not configured with harq-ACK-SpatialBundlingPUCCH or harq-ACK-SpatialBudlingPUSCH the cell group or PUCCH group, the UE 120 may generate two HARQ ACK bits. Alternatively, when the UE 120 is not configured with the parameter maxNrofCodeWordsScheduledByDCI or when the UE 120 is configured with either of the parameters harq-ACK-SpatialBundlingPUCCH or harq-ACK-SpatialBudlingPUSCH, the UE 120 may generate one HARQ ACK bit.

Similarly, in the case of dynamic DCI format indication, the UE 120 may generate, for multi-cell scheduling, a quantity Nmax HARQ bits per DAI count. In some aspects, the parameter Nmax may be Nmax=NPDSCH×NTB. When the UE 120 is configured with maxNrofCodeWordsScheduledByDCI with two transport blocks for at least one downlink bandwidth part of at least one serving cell in a cell group or PUCCH group, and when the UE 120 is not configured with harq-ACK-SpatialBundlingPUCCH or harq-ACK-SpatialBudlingPUSCH parameter in the cell group or PUCCH group, the quantity of transport blocks is two. Alternatively, when the UE 120 is not configured with maxNrofCodeWordsScheduledByDCI or when the UE 120 is configured with either harq-ACK-SpatialBundlingPUCCH or harq-ACK-SpatialBudlingPUSCH, the quantity of transport blocks is one. Alternatively, the UE 120 may set the quantity of transport blocks as one in any serving cell where a DCI for multi-cell scheduling can schedule PDSCHs.

FIGS. 7C and 7D show examples of the T-DAI for the UE 120 when the UE 120 is scheduled with a first format of DCI associated with single-cell scheduling and a second format of DCI associated with multi-cell scheduling. As shown in FIG. 7C, the UE 120 monitors for single-cell scheduling DCI on carriers #0, #1, and #4, but only monitors for multi-cell scheduling DCI on carrier #1. As shown, the T-DAI is included in the DCI when the UE 120 is configured with more than one downlink cell for monitoring a DCI format for single-cell scheduling or for multi-cell scheduling. In this case, the T-DAI is not included when the UE 120 is not configured with more than one downlink cell for monitoring a DCI for single-cell scheduling or for multi-cell scheduling, even when multiple downlink cells are configured in a carrier aggregation configuration. Accordingly, the T-DAI is not included for the DCI for multi-cell scheduling as shown (via a strikethrough) in FIG. 7C. As an alternative, T-DAI may be included in DCI even if the UE 120 is configured with only a single downlink cell for monitoring DCI for multi-cell scheduling. In another example, in FIG. 7D, when the T-DAI is not to be included (e.g., as a result of only a single cell being configured for, for example, multi-cell scheduling), the T-DAI may be repurposed and the UE 120 may interpret the T-DAI value in accordance with the repurposing. For example, as shown in FIG. 7D (via underlining), the T-DAI value for the multi-cell scheduling DCI is used as a repetition of the T-DAI value for the single-cell scheduling DCI in the same carrier (carrier #1), thereby improving reliability.

As indicated above, FIGS. 7A-7D is provided as examples. Other examples may differ from what is described with respect to FIGS. 7A-7D.

FIG. 8 is a diagram illustrating an example process 800 performed, for example, by a UE, in accordance with the present disclosure. Example process 800 is an example where the UE (e.g., UE 120) performs operations associated with using a HARQ feedback codebook in a multi-cell scheduling scenario.

As shown in FIG. 8, in some aspects, process 800 may include receiving DCI scheduling one or more PDSCH communications (block 810). For example, the UE (e.g., using communication manager 140 and/or reception component 1002, depicted in FIG. 10) may receive DCI scheduling one or more PDSCH communications, as described above. In some aspects, the one or more PDSCH communications may be scheduled on one or more carriers.

As further shown in FIG. 8, in some aspects, process 800 may include receiving the one or more PDSCH communications in accordance with the DCI (block 820). For example, the UE (e.g., using communication manager 140 and/or reception component 1002, depicted in FIG. 10) may receive the one or more PDSCH communications in accordance with the DCI, as described above. In some aspects, the one or more PDSCH communications may be received on one or more carriers.

As further shown in FIG. 8, in some aspects, process 800 may include transmitting, for the one or more PDSCH communications, HARQ feedback using a sub-codebook of a set of sub-codebooks (block 830). For example, the UE (e.g., using communication manager 140 and/or transmission component 1004, depicted in FIG. 10) may transmit, for the one or more PDSCH communications, HARQ feedback using a sub-codebook of a set of sub-codebooks, as described above. In some aspects, the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Process 800 may include additional aspects, such as any single aspect or any combination of aspects described below and/or in connection with one or more other processes described elsewhere herein.

In a first aspect, the set of sub-codebooks are concatenated to form a single HARQ codebook for both single-cell scheduling and multi-cell scheduling.

In a second aspect, alone or in combination with the first aspect, a C-DAI value for the DCI is incremented on a per-sub-codebook basis for the set of sub-codebooks.

In a third aspect, alone or in combination with one or more of the first and second aspects, a T-DAI value for the DCI is incremented on a per-sub-codebook basis for the set of sub-codebooks.

In a fourth aspect, alone or in combination with one or more of the first through third aspects, whether the DCI is the first format or the second format is semi-statically configured for a cell.

In a fifth aspect, alone or in combination with one or more of the first through fourth aspects, whether the DCI is the first format or the second format is dynamically indicated for a cell.

In a sixth aspect, alone or in combination with one or more of the first through fifth aspects, the DCI is the first format, and a quantity of HARQ bits of the HARQ feedback is based at least in part on a configuration of the UE.

In a seventh aspect, alone or in combination with one or more of the first through sixth aspects, the DCI is the second format, and a quantity of HARQ bits of the HARQ feedback is based at least in part on at least one of a UE configuration or a radio resource control configured parameter.

In an eighth aspect, alone or in combination with one or more of the first through seventh aspects, a spatial bundling parameter for the HARQ feedback is configured on a per cell basis and based at least in part on whether the DCI is the first format or the second format.

In a ninth aspect, alone or in combination with one or more of the first through eighth aspects, a T-DAI parameter is included in the DCI based at least in part on a quantity of downlink cells configured for the UE to monitor for the DCI.

In a tenth aspect, alone or in combination with one or more of the first through ninth aspects, the UE is configured to interpret a T-DAI parameter included in the DCI based at least in part on a quantity of downlink cells configured for the UE to monitor for the DCI.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., the network node 110, the CU 310, the DU 330, or the RU 340) performs operations associated with using a HARQ feedback codebook in a multi-cell scheduling scenario.

As shown in FIG. 9, in some aspects, process 900 may include transmitting DCI scheduling one or more PDSCH communications (block 910). For example, the network node (e.g., using communication manager 150 and/or transmission component 1104, depicted in FIG. 11) may transmit DCI scheduling one or more PDSCH communications, as described above. In some aspects, the one or more PDSCH communications may be scheduled on one or more carriers.

As further shown in FIG. 9, in some aspects, process 900 may include transmitting the one or more PDSCH communications in accordance with the DCI (block 920). For example, the network node (e.g., using communication manager 150 and/or transmission component 1104, depicted in FIG. 11) may transmit the one or more PDSCH communications in accordance with the DCI, as described above. In some aspects, the one or more PDSCH communications may be transmitted on one or more carriers.

As further shown in FIG. 9, in some aspects, process 900 may include receiving, for the one or more PDSCH communications, HARQ feedback transmitted using a sub-codebook of a set of sub-codebooks (block 930). For example, the network node (e.g., using communication manager 150 and/or reception component 1102, depicted in FIG. 11) may receive, for the one or more PDSCH communications, HARQ feedback transmitted using a sub-codebook of a set of sub-codebooks, as described above. In some aspects, the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers, as described above.

Process 900 may include additional aspects, such as any single aspect or any combination of aspects described below and/or in connection with one or more other processes described elsewhere herein.

In a first aspect, the set of sub-codebooks are concatenated to form a single HARQ codebook for both single-cell scheduling and multi-cell scheduling.

In a second aspect, alone or in combination with the first aspect, a C-DAI value for the DCI is incremented on a per-sub-codebook basis for the set of sub-codebooks.

In a third aspect, alone or in combination with one or more of the first and second aspects, a T-DAI value for the DCI is incremented on a per-sub-codebook basis for the set of sub-codebooks.

In a fourth aspect, alone or in combination with one or more of the first through third aspects, whether the DCI is the first format or the second format is semi-statically configured for a cell.

In a fifth aspect, alone or in combination with one or more of the first through fourth aspects, whether the DCI is the first format or the second format is dynamically indicated for a cell.

In a sixth aspect, alone or in combination with one or more of the first through fifth aspects, the DCI is the first format, and a quantity of HARQ bits of the HARQ feedback is based at least in part on a configuration of a UE.

In a seventh aspect, alone or in combination with one or more of the first through sixth aspects, the DCI is the second format, and a quantity of HARQ bits of the HARQ feedback is based at least in part on at least one of a UE configuration or a radio resource control configured parameter.

In an eighth aspect, alone or in combination with one or more of the first through seventh aspects, a spatial bundling parameter for the HARQ feedback is configured on a per cell basis and based at least in part on whether the DCI is the first format or the second format.

In a ninth aspect, alone or in combination with one or more of the first through eighth aspects, a T-DAI parameter is included in the DCI based at least in part on a quantity of downlink cells configured for a UE to monitor for the DCI.

In a tenth aspect, alone or in combination with one or more of the first through ninth aspects, a UE is configured to interpret a T-DAI parameter included in the DCI based at least in part on a quantity of downlink cells configured for a UE to monitor for the DCI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a determination component 1008, among other examples.

In some aspects, the apparatus 1000 may be configured to perform one or more operations described herein in connection with FIGS. 7A-7D. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive DCI scheduling one or more PDSCH communications. The reception component 1002 may receive the one or more PDSCH communications in accordance with the DCI. The transmission component 1004 may transmit, for the one or more PDSCH communications, HARQ feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers. The determination component 1008 may construct and/or determine a codebook to use for transmitting HARQ feedback.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIGS. 7A-7D. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit DCI scheduling one or more PDSCH communications. The transmission component 1104 may transmit the one or more PDSCH communications in accordance with the DCI. The reception component 1102 may receive, for the one or more PDSCH communications, HARQ feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers. The determination component 1108 may determine a configuration for the apparatus 1106 to use for constructing a codebook.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving physical downlink shared channel (PDSCH) communications scheduled by downlink control information (DCI); and transmitting, for the one or more PDSCH communications, hybrid automatic repeat request (HARQ) feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Aspect 2: The method of Aspect 1, further comprising: receiving the DCI scheduling the one or more PDSCH communications.

Aspect 3: The method of any of Aspects 1 to 2, wherein the set of sub-codebooks are concatenated to form a single HARQ codebook for both single-cell scheduling and multi-cell scheduling.

Aspect 4: The method of any of Aspects 1 to 3, wherein a counter downlink assignment index (C-DAI) value for the DCI is incremented on a per-sub-codebook basis for the set of sub-codebooks.

Aspect 5: The method of any of Aspects 1 to 4, wherein a total downlink assignment index (T-DAI) value for the DCI is incremented on a per-sub-codebook basis for the set of sub-codebooks.

Aspect 6: The method of any of Aspects 1 to 5, wherein whether the DCI is the first format or the second format is semi-statically configured for a cell.

Aspect 7: The method of any of Aspects 1 to 6, wherein whether the DCI is the first format or the second format is dynamically indicated for a cell.

Aspect 8: The method of any of Aspects 1 to 7, wherein the DCI is the first format, and wherein a quantity of HARQ bits of the HARQ feedback is based at least in part on a configuration of the UE.

Aspect 9: The method of any of Aspects 1 to 8, wherein the DCI is the second format, and wherein a quantity of HARQ bits of the HARQ feedback is based at least in part on at least one of a UE configuration or a radio resource control configured parameter.

Aspect 10: The method of any of Aspects 1 to 9, wherein a spatial bundling parameter for the HARQ feedback is configured on a per cell basis and based at least in part on whether the DCI is the first format or the second format.

Aspect 11: The method of any of Aspects 1 to 10, wherein a total downlink assignment index (T-DAI) parameter is included in the DCI based at least in part on a quantity of downlink cells configured for the UE to monitor for the DCI.

Aspect 12: The method of any of Aspects 1 to 11, wherein the UE is configured to interpret a total downlink assignment index (T-DAI) parameter included in the DCI based at least in part on a quantity of downlink cells configured for the UE to monitor for the DCI.

Aspect 13: A method of wireless communication performed by a network node, comprising: transmitting physical downlink shared channel (PDSCH) communications scheduled by downlink control information (DCI); and receiving, for the one or more PDSCH communications, hybrid automatic repeat request (HARQ) feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

Aspect 14: The method of Aspect 13, further comprising: receiving the DCI scheduling the one or more PDSCH communications.

Aspect 15: The method of any of Aspects 13 to 14, wherein the set of sub-codebooks are concatenated to form a single HARQ codebook for both single-cell scheduling and multi-cell scheduling.

Aspect 16: The method of any of Aspects 13 to 15, wherein a counter downlink assignment index (C-DAI) value for the DCI is incremented on a per-sub-codebook basis for the set of sub-codebooks.

Aspect 17: The method of any of Aspects 13 to 16, wherein a total downlink assignment index (T-DAI) value for the DCI is incremented on a per-sub-codebook basis for the set of sub-codebooks.

Aspect 18: The method of any of Aspects 13 to 17, wherein whether the DCI is the first format or the second format is semi-statically configured for a cell.

Aspect 19: The method of any of Aspects 13 to 18, wherein whether the DCI is the first format or the second format is dynamically indicated for a cell.

Aspect 20: The method of any of Aspects 13 to 19, wherein the DCI is the first format, and wherein a quantity of HARQ bits of the HARQ feedback is based at least in part on a configuration of a user equipment.

Aspect 21: The method of any of Aspects 13 to 20, wherein the DCI is the second format, and wherein a quantity of HARQ bits of the HARQ feedback is based at least in part on at least one of a user equipment configuration or a radio resource control configured parameter.

Aspect 22: The method of any of Aspects 13 to 21, wherein a spatial bundling parameter for the HARQ feedback is configured on a per cell basis and based at least in part on whether the DCI is the first format or the second format.

Aspect 23: The method of any of Aspects 13 to 22, wherein a total downlink assignment index (T-DAI) parameter is included in the DCI based at least in part on a quantity of downlink cells configured for the user equipment to monitor for the DCI.

Aspect 24: The method of any of Aspects 13 to 23, wherein the UE is configured to interpret a total downlink assignment index (T-DAI) parameter included in the DCI based at least in part on a quantity of downlink cells configured for the user equipment to monitor for the DCI.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive one or more physical downlink shared channel (PDSCH) communications scheduled by downlink control information (DCI); and
transmit, for the one or more PDSCH communications, hybrid automatic repeat request (HARQ) feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

2. The UE of claim 1, wherein the one or more processors are further configured to cause the UE to:
receive the DCI scheduling the one or more PDSCH communications.

3. The UE of claim 1, wherein the set of sub-codebooks are concatenated to form a single HARQ codebook for both single-cell scheduling and multi-cell scheduling.

4. The UE of claim 1, wherein a counter downlink assignment index (C-DAI) value for the DCI is incremented on a per-sub-codebook basis for the set of sub-codebooks.

5. The UE of claim 1, wherein a total downlink assignment index (T-DAI) value for the DCI is incremented on a per-sub-codebook basis for the set of sub-codebooks.

6. The UE of claim 1, wherein whether the DCI is the first format or the second format is semi-statically configured for a cell.

7. The UE of claim 1, wherein whether the DCI is the first format or the second format is dynamically indicated for a cell.

8. The UE of claim 1, wherein the DCI is the first format, and
wherein a quantity of HARQ bits of the HARQ feedback is based at least in part on a configuration of the UE.

9. The UE of claim 1, wherein the DCI is the second format, and
wherein a quantity of HARQ bits of the HARQ feedback is based at least in part on at least one of a UE configuration or a radio resource control configured parameter.

10. The UE of claim 1, wherein a spatial bundling parameter for the HARQ feedback is configured on a per cell basis and based at least in part on whether the DCI is the first format or the second format.

11. The UE of claim 1, wherein a total downlink assignment index (T-DAI) parameter is included in the DCI based at least in part on a quantity of downlink cells configured for the UE to monitor for the DCI.

12. The UE of claim 1, wherein the UE is configured to interpret a total downlink assignment index (T-DAI) parameter included in the DCI based at least in part on a quantity of downlink cells configured for the UE to monitor for the DCI.

13. A network node for wireless communication, comprising:
a memory; and
one or more processors, coupled to the memory, configured to:
transmit one or more physical downlink shared channel (PDSCH) communications scheduled by downlink control information (DCI); and
receive, for the one or more PDSCH communications, hybrid automatic repeat request (HARQ) feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

14. The network node of claim 13, wherein the one or more processors are further configured to cause the network node to:
transmit the DCI scheduling the one or more PDSCH communications.

15. The network node of claim 13, wherein the set of sub-codebooks are concatenated to form a single HARQ codebook for both single-cell scheduling and multi-cell scheduling.

16. The network node of claim 13, wherein a counter downlink assignment index (C-DAI) value for the DCI is incremented on a per-sub-codebook basis for the set of sub-codebooks.

17. The network node of claim 13, wherein a total downlink assignment index (T-DAI) value for the DCI is incremented on a per-sub-codebook basis for the set of sub-codebooks.

18. The network node of claim 13, wherein whether the DCI is the first format or the second format is semi-statically configured for a cell.

19. The network node of claim 13, wherein whether the DCI is the first format or the second format is dynamically indicated for a cell.

20. The network node of claim 13, wherein the DCI is the first format, and
wherein a quantity of HARQ bits of the HARQ feedback is based at least in part on a configuration of a user equipment.

21. The network node of claim 13, wherein the DCI is the second format, and
wherein a quantity of HARQ bits of the HARQ feedback is based at least in part on at least one of a user equipment configuration or a radio resource control configured parameter.

22. The network node of claim 13, wherein a spatial bundling parameter for the HARQ feedback is configured on a per cell basis and based at least in part on whether the DCI is the first format or the second format.

23. The network node of claim 13, wherein a total downlink assignment index (T-DAI) parameter is included in the DCI based at least in part on a quantity of downlink cells configured for a user equipment to monitor for the DCI.

24. The network node of claim 13, wherein a user equipment is configured to interpret a total downlink assignment index (T-DAI) parameter included in the DCI based at least in part on a quantity of downlink cells configured for the user equipment to monitor for the DCI.

25. A method of wireless communication performed by a user equipment (UE), comprising:
receiving one or more physical downlink shared channel (PDSCH) communications scheduled by downlink control information (DCI); and
transmitting, for the one or more PDSCH communications, hybrid automatic repeat request (HARQ) feedback using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

26. The method of claim 25, wherein the set of sub-codebooks are concatenated to form a single HARQ codebook for both single-cell scheduling and multi-cell scheduling.

27. The method of claim 25, wherein a counter downlink assignment index (C-DAI) value for the DCI is incremented on a per-sub-codebook basis for the set of sub-codebooks.

28. A method of wireless communication performed by a network node, comprising:
transmitting one or more physical downlink shared channel (PDSCH) communications scheduled by downlink control information (DCI); and
receiving, for the one or more PDSCH communications, hybrid automatic repeat request (HARQ) feedback transmitted using a sub-codebook of a set of sub-codebooks, wherein the sub-codebook is a single-cell scheduling sub-codebook, of the set of sub-codebooks, or a multi-cell scheduling sub-codebook, of the set of sub-codebooks, based at least in part on whether the DCI is a first format configured for scheduling the one or more PDSCH communications on a single carrier or a second format configured for scheduling the one or more PDSCH communications on a plurality of carriers.

29. The method of claim 28, wherein the set of sub-codebooks are concatenated to form a single HARQ codebook for both single-cell scheduling and multi-cell scheduling.

30. The method of claim 28, wherein a counter downlink assignment index (C-DAI) value for the DCI is incremented on a per-sub-codebook basis for the set of sub-codebooks.
